(19) United States
(12) Patent Application Publication
(10) Pub. No.: US 2004/0082711 A1
(43) Pub. Date: Apr. 29, 2004

(54) Hydrophobic binder mixture with low water absorption

(76) Inventors: Meike Niesten, Koln (DE); Thomas Stingl, Montabaur (DE); Joachim Simon, Dusseldorf (DE); Christian Wamprecht, Neuss (DE)

Correspondence Address: BAYER POLYMERS LLC, 100 BAYER ROAD, PITTSBURGH, PA, 15205, US

(21) Appl. No.: 10/687,716

(22) Filed: Oct. 17, 2003

(30) Foreign Application Priority Data
Oct. 18, 2002 (DE) 10248618.2

(51) Int. Cl. C08K 3/00; C08K 5/05

(52) U.S. Cl. 524/589; 524/379

(57) ABSTRACT

The invention relates to solvent-free binder mixtures suitable for preparing two-component coating compositions, particularly for high-build applications, and to a process for preparing them.

### CROSS REFERENCE TO RELATED PATENT APPLICATION

The present patent application claims the right of priority under 35 U.S.C. § 119 (a)-(d) of German Patent Application No. 102 48 618.2, filed Oct. 18, 2002.

### FIELD OF THE INVENTION

The invention relates to solvent-free binder mixtures suitable for preparing two-component coating compositions, particularly for high-build applications, and to a process for preparing them.

### BACKGROUND OF THE INVENTION

Prior art solvent-free coating systems can be divided roughly into two-component epoxy resin (2K EP) systems and two-component polyurethane (2K PU) systems.

Coatings based on 2K EP systems combine good mechanical strength with high resistance to solvents and chemicals. In addition they feature very good substrate adhesion. A distinct disadvantage is the poor elasticity of 2K EP coatings, particularly at low temperatures (e.g. in Kunststoff-Handbuch, Vol. 7; Polyurethane, 2^{nd} edition, G. Oertel (ed.), Hanser Verlag, Munich, Vienna, 1983, pp. 556-8). This brittleness leads to poor crack bridging by the coating, with the consequence that an attack on the substrate may occur here. An additional disadvantage is the very low stability to organic acids. This is a problem in particular for applications in the food sector, where organic acids are released as waste products.

A balanced combination of hardness and elasticity, in contrast, is the outstanding property of the 2K PU coatings and the greatest advantage over 2K EP coatings. Furthermore, with similar solvent and chemical resistances, the resistance to organic acids of 2K PU coatings is substantially better than 2K EP coatings.

For environmental reasons coating compositions ought to be solvent-free, particularly in the case of high-build applications, such as floor coatings for example. This means that the viscosity of the binder component ought to be low.

In high-build applications based on 2K PU systems the risk exists of blistering by the formation of CO₂ as a consequence of the water-isocyanate reaction. Consequently a very low water absorption of the raw materials is important in order that such coatings can be applied without blisters even in a damp environment. The hydroxy-functional component is generally more hydrophilic than the polyisocyanate component. It is therefore particularly important to employ hydrophobic hydroxy-functional components.

The hydroxy-functional binder component of the 2K PU coating may be based on a variety of types of chemical structure (e.g. Lehrbuch der Lacke und Beschichtungen, Vol. 2; pp. 205-209, H. Kittel, S. Hirzel Verlag, Stuttgart, Leipzig, 1998). Polyesterpolyols possess a low viscosity and feature a relatively low water absorption. The stability of the polyesterpolyols to hydrolysis, however, is low, thereby severely restricting the possibility of using them for corrosion prevention on metallic substrates and for coating mineral (alkaline) substrates. 2K PU coatings based on polyacrylate polyols feature good resistance to hydrolysis. A disadvantage here, however, is the relatively high viscosity level. Polyetherpolyols, in contrast, exhibit low viscosity and high stability to hydrolysis, but the high water absorption is a drawback.

EP-A 0 580 054 describes hydroxy-functional polyester-polyacrylate binders. These products exhibit a low viscosity and good mechanical strength in the 2K PU coatings produced from them. The stability to hydrolysis, however, is inadequate and the water absorption is too high for high-build applications in the floor coating or corrosion prevention sector.

EP-A 0 825 210 describes polyether acrylates. Although stable to hydrolysis and of low viscosity, these products too have a water absorption too high for high-build applications.

Sufficient hydrophobicity in solvent-free polyols is often achieved in the prior art through the use of castor oil. The 2K PU coatings produced with castor oil, however, are too soft for application in floor coating (e.g. Saunders, Frisch; Polyurethanes, Chemistry and Technology, Part 1 Chemistry pages 48 to 53, 314 and Part 2 Technology, chapter X).

An object of the present invention was therefore to provide a solvent-free binder mixture of low viscosity that is suitable for producing two-component systems, can be applied without blisters in high-build applications, and possesses sufficient hardness. Blister-free application presupposes a low water absorption, which at the same time should ensure an adequate pot life. The coatings produced with the binders of the invention ought further to possess good elasticity, chemical resistance and acid resistance.

### SUMMARY OF THE INVENTION

The present invention is directed to a solvent-free binder mixture that includes a hydrophobic polyether polyacrylate (A), which includes the reaction product of (A1) a mixture of non-hydroxy-functional acrylic and styrenic monomers or copolymers thereof, (A2) hydroxy-functional polyethers, and optionally (A3) hydroxy-functional compounds having a molecular weight Mₙ of from 32 to 1000 which are other than (A2). The solvent-free binder mixture has a water absorption of less than 8%, (measured after 21 days and at 23° C).

The present invention is further directed to a process for preparing the solvent-free binder mixture described above.

The invention is also directed to two-component polyurethane coating compositions containing the above-described solvent-free binder mixture as well as a metallic substrate or a mineral substrate coated by or using the present two-component polyurethane coating compositions.

### DETAILED DESCRIPTION OF THE INVENTION

Other than in the operating examples, or where otherwise indicated, all numbers or expressions referring to quantities of ingredients, reaction conditions, etc. used in the specification and claims are to be understood as modified in all instances by the term “about.”

The object of the invention has been achieved by the provision of a binder mixture comprising a hydrophobic polyether polyacrylate based on non-hydroy-functional acrylic and styrenic monomers.

The invention provides solvent-free binder mixtures that include a hydrophobic polyether polyacrylate (A) which is a reaction product of:

(A1) a mixture of non-hydroxy-functional acrylic and styrenic monomers or copolymers thereof,

(A2) hydroxy-functional polyethers (A2),

(A3) if desired, hydroxy-functional compounds having a molecular weight Mₙ of from 32 to 1000 which are other than (A2),

where the solvent-free binder mixture having a water absorption of less than 8%, in some cases less than 5% (measured after 21 days and at 23° C.).

In addition to the hydrophobic polyether polyacrylate (A) the binder mixtures of the invention can include a fatty alcohol (B), a non-limiting example of such being castor oil.

Likewise provided by the present invention is a two-component polyurethane coating composition that includes the binder mixture of the invention and a polyisocyanate (C), the NCO:OH equivalents ratio being between 0.5:1 to 2.0:1, preferably 0.8:1 to 1.5:1.

Suitable polyisocyanate components (C) include, but are not limited to organic polyisocyanates having an average NCO functionality of at least 2 and a molecular weight of at least 140 g/mol. In an embodiment of the invention, the polyisocyanate components (C) can be (i) unmodified organic polyisocyanates of the molecular weight range 140 to 300 g/mol, (ii) paint polyisocyanates with a molecular weight in the range from 300 to 1000 g/mol, and (iii) NCO prepolymers containing urethane groups and having a molecular weight of more than 1000 g/mol, or mixtures of (i) to (iii).

Non-limiting examples of polyisocyanates of group (i) are 1,4-diisocyanatobutane, 1,6-diisocyanatohexane (HDI), 1,5-diisocyanato-2,2-dimethylpentane, 2,2,4- and 2,4,4-trimethyl-1,6-diisocyanatohexane, 1-isocyanato-3,3,5-trimethyl-5-iso-cyanatomethyl-cyclohexane (IPDI), 1-isocyanato-1-methyl-4-(3)-isocyanato-methylcyclohexane, bis-(4-isocyanatocyclohexyl)methane, 1,10-diisocyanato-decane, 1,12-diisocyanatododecane, cyclohexane 1,3- and 1,4-diisocyanate, xylylene diisocyanate isomers, triisocyanatononane (TIN), 2,4-diisocyanato-toluene or its mixtures with 2,6-diisocyanatotoluene with preferably, based on mixtures, up to 35% by weight of 2,6-diisocyanatotoluene, 2,2′-, 2,4′-, 4,4′-, diisocyanatodiphenylmethane or technical-grade polyisocyanate mixtures of the diphenylmethane series, or any desired mixtures of the isocyanates stated. Preference is given in this case to employing the polyisocyanates of the diphenylmethane series, with particular preference in the form of isomer mixtures.

Non-limiting examples of the polyisocyanates of group (ii) include the paint polyisocyanates known per se. The term “coating polyisocyanates” in the context of the invention is used for compounds or mixtures of compounds which are obtained by conventional oligomerization reaction of simple diisocyanates of the type mentioned by way of example under (i). Examples of suitable oligomerization reactions include, but are not limited to carbodiimidization, dimerization, trimerization, biuretization, urea formation, urethanization, allophanatization and/or cyclization with the formation of oxadiazine structures. In the course of “oligomerization” it is often the case that two or more of the reactions stated run simultaneously or in succession.

In an embodiment of the invention, the “coating polyisocyanates” (ii) are biuret polyisocyanates, polyisocyanates containing isocyanurate groups, polyisocyanate mixtures containing isocyanurate and uretdione groups, polyisocyanates containing urethane and/or allophanate groups, or polyisocyanate mixtures containing isocyanurate and allophanate groups and based on simple diisocyanates.

The preparation of coating polyisocyanates of this kind is known and is described for example in DE-A 1 595 273, DE-A 3 700 209 and DE-A 3 900 053 or in EP-A-0 330 966, EP-A 0 259 233, EP-A-0 377 177, EP-A-0 496 208, EP-A-0 524 501 or U.S. Pat. No. 4,385,171.

In an embodiment of the invention, the polyisocyanates of group (iii) are the conventional isocyanato-functional prepolymers based on simple diisocyanates of the type exemplified above and/or based on coating polyisocyanates (ii) on the one hand and organic polyhydroxy compounds with a molecular weight of more than 300 g/mol on the other hand. Whereas the coating polyisocyanates of group (ii) which contain urethane groups are derivatives of low molecular weight polyols of the molecular weight range 62 to 300 g/mol—suitable polyols are, for example, ethylene glycol, propylene glycol, trimethylolpropane, glycerol or mixtures of these alcohols—the NCO prepolymers of group (iii) are prepared using polyhydroxyl compounds whose molecular weight is over 300 g/mol, preferably over 500 g/mol, more preferably between 500 and 8000 g/mol. Particular such polyhydroxyl compounds of this kind are those which contain per molecule from 2 to 6, preferably from 2 to 3, hydroxyl groups and are selected from the group consisting of ether, ester, thioether, carbonate, and polyacrylate poloyols and mixtures of such polyols.

In the preparation of the NCO prepolymers (iii) it is also possible for the relatively high molecular weight polyols stated to be employed in blends with the low molecular weight polyols stated, so leading directly to mixtures of low molecular weight paint polyisocyanates (ii) containing urethane groups and relatively high molecular weight NCO prepolymers (iii), which are likewise suitable as a starting component (C) according to the invention.

In an embodiment of the invention and in order to prepare NCO prepolymers (iii) or mixtures thereof with the coating polyisocyanates (ii), diisocyanates (i) of the type exemplified above or coating polyisocyanates of the type exemplified under (ii) are reacted with the relatively high molecular weight hydroxyl compounds or mixtures thereof with low molecular weight polyhydroxyl compounds of the type exemplified, observing an NCO/OH equivalents ratio of from 1.1:1 bis 40:1, preferably 2:1 to 25:1, with formation of urethanes. Optionally, using an excess of distillable starting diisocyanate, it is possible to remove this diisocyanate by distillation following the reaction, so that monomer-free NCO prepolymers, i.e. mixtures of starting diisocyanates (i) and true NCO prepolymers (iii), are obtained which may likewise be used as component (A).

The organic polyether polyacrylate component (A) has a hydroxyl group content of from 3.0 to 10% by weight, in some cases from 5.0 to 9% by weight, and a viscosity at 23° C. of from 200 to 3000 mPa.s, in some cases from 400 to 2800 mPa.s.

In an embodiment of the present invention, Component (A) is prepared by free-radical addition polymerization of

(A1) from 10 to 50 parts by weight, preferably from 15 to 40 parts by weight of a mixture of non-hydroxy-functional acrylic and styrenic monomers or copolymers thereof, the fraction of styrene monomer being from 10 to 80%, preferably from 20 to 50%, based on component (A1),

(A2) from 15 to 90 parts by weight, preferably from 20 to 85 parts by weight of one or more hydroxy-functional polyethers having an OH functionality of greater than or equal to 2, and

(A3) from 0 to 50 parts by weight of hydroxy-functional compounds having a molecular weight Mₙ of from 32 to 1000 which are other than (A2), the mixture of (A2) and (A3) including at least 30 parts by weight of (A2),

in the presence of polymerization initiators (D) and also, optionally, further auxiliaries and additives.

Following the polymerization from 0 to 80 parts by weight, preferably from 10 to 60 parts by weight, of fatty alcohols (B), a non-limiting example of which being castor oil, are added.

The monomers (A1) are monounsaturated compounds of the molecular weight range from 50 to 400 g/mol, in some cases from 80 to 220 g/mol. The non-hydroxy-functional acrylates include for example acrylic or methacrylic alkyl or cycloalkyl esters having 1 to 18, in some cases 1 to 8 carbon atoms with alkyl, cycloalkyl radical such as, for example, methyl, ethyl, n-propyl, n-butyl, isopropyl, isobutyl, t-butyl, the isomeric pentyl, hexyl, octyl, dodecyl, hexadecyl or octadecyl esters of the stated acids, acetoacetoxyethyl methacrylate, acrylonitrile or methacrylonitrile. Instead of styrene it is also possible to use vinyltoluene. Mixtures of the monomers can also be used. Advantageous monomers (A1) that can be used in the invention include, but are not limited tostyrene, methyl methacrylate and butyl acrylate.

Suitable hydroxy-functional components (A2) include monohydric or polyhydric alcohols of the molecular weight range from 108 to 2000 g/mol, in some cases from 192 to 1100 g/mol, which contain ether groups, or mixtures of such alcohols. Preference is given to polyetherpolyols having 2 or more hydroxyl groups per molecule, such as are obtainable conventionally by addition reaction of cyclic ethers, such as propylene oxide, styrene oxide, butylene oxide or tetrahydrofuran, with starter molecules such as water, polyhydric alcohols free of ether groups, amino alcohols or amines. Particular preference is given to polyethers composed of at least 50%, preferably at least 90%, based on the sum of their repeating units, of repeating units of the structure —CH(CH₃)CH₂O—.

Suitable starter molecules for this purpose include, but are not limited to polyhydric alcohols such as for example ethylene glycol, propane-1,2- and -1,3-diol, butane-1,2-, 1,3-, -1,4- and -2,3-diol, pentane-1,5-diol, 3-methylpentane-1,5-diol, hexane-1,6-diol, octane-1,8-diol, 2-methylpropane-1,3-diol, 2,2-dimethly-propane-1,3-diol, 2-ethyl-2-butylpropane-1,3-diol, 2,2,4-trimethylpentane-1,3-diol, 2-ethylhexane-1,3-diol, relatively high molecular weight α,ω-alkanediols having 9 to 18 carbon atoms, cyclohexanedimethanol, cyclohexanediols, glycerol, trimethylolpropane, butane-1,2,4-diol, hexane-1,2,6-triol, bis(trimethylolpropane), pentaerythritol, mannitol or methyl glycoside. Preference is given to the starters with a functionality of three or more such as for example trimethylolpropane, glycerol, hexanetriol, pentaerythritol, 2-aminoethanol, ethylenediamine with ethers based on propylene oxide or tetrahydrofuran.

Non-limiting examples of suitable amino alcohols include 2-aminoethanol, 2-(methylamino)ethanol, diethanolamine, 3-amino-1-propanol, 1-amino-2-propanol, diisopropanolamine, 2-amino-2-hydroxymethyl-1,3-propanediol or mixtures thereof.

Particularly suitable polyfunctional amines include, but are not limited to aliphatic or cycloaliphatic amines, such as ethylenediamine, 1,2-diaminopropane, 1,3-diaminopropane, 1,4-diaminobutane, 1,3-diamino-2-2-dimethylpropane, 4,4-diaminodicyclohexylmethane, isophoronediamine, hexamethylenediamine, 1,12-dodecanediamine or mixtures thereof.

In addition to the polyetherpolyols described, having a functionality of two or more, it is also possible where appropriate to use monohydroxy polyethers alone or as a mixture with polyetherpolyols of higher functionality. Monohydroxy polyethers can be obtained in analogy to the abovementioned polyetherpolyols by addition reaction of the abovementioned cyclic ethers with monoalcohols, especially linear or branched aliphatic or cycloaliphatic monohydroxyalkanes, such as methanol, ethanol, propanol, butanol, hexanol, octanol, 2-ethylhexanol, cyclohexanol or stearyl alcohol, for example, or secondary aliphatic or cycloaliphatic monoamines, such as dimethylamine, diethylamine, diisopropyl-amine, dibutylamine, N-methylstearylamine, piperidine or morpholine, for example. Particular preference, however, is given to using polyetherpolyols of relatively high functionality, especially those having 2 or 3 hydroxyl groups per polyether molecule.

It is likewise possible for preparing component (A) to use hydroxy compounds of molar weight 32 to 1000 g/mol having a functionality of at least 2 as component (A3). In this embodiment of the invention, use is made of low molecular weight hydroxy compounds of molecular weight 32 to 350 g/mol, such as -1,2-, -1,3-, -1,4- and -2,3-diol, pentane-1,5-diol, 3-methylpentane-1,5-diol, hexane-1,6-diol, 2-ethylhexane-1,3-diol, 2-methylpropane-1,3-diol, 2,2-dimethylpropane-1,3-diol, 2-butyl-2-ethylpropane-1,3-diol, 2,2,4-trimethylpentane-1,3-diol, octane-1,8-diol, relatively high molecular weight α,ω-alkanediols having 9 to 18 carbon atoms, cyclohexanedimethanol, cyclohexanediol, glycerol, trimethylolpropane, butane-1,2,4-triol, hexane-1,2,6-triol, bis(trimethylolpropane), pentaerythritol, mannitol or methyl glycoside. The hydroxypolyesters, hydroxypolyesteramides, hydroxypolycarbonates or hydroxypolyacetals known per se from polyurethane chemistry, up to a molecular weight of 1000 g/mol, may likewise be employed.

Suitable fatty alcohols (B) are compounds containing one or more hydroxyl groups. The hydroxyl groups can be joined to saturated, unsaturated, unbranched or branched alkyl radicals having more than 8, in particular more than 12, carbon atoms. They may contain further groups such as, for example, ether, ester, halogen, amide, amino, urea, and urethane groups. Specific examples are castor oil, 12-hydroxystearyl alcohol, oleyl alcohol, erucyl alcohol, linoley alcohol, linolenyl alcohol, arachidyl alcohol, gadoleyl alcohol, erucyl alcohol, brassidyl alcohol or dimerdiol (=hydrogenation product of dimer fatty acid methyl ester), preference being given to castor oil.

In the preparation of the polyether polyacrylate component (A) containing in the binder mixture of the invention the weight ratio of component (A1) to the sum of component (A2 and A3) is from 10:90 to 50:50, preferably from 15:85 to 40:60, the weight ratio of component (A2) to component (A3) being between 30:70 and 100:0, and the weight ratio of the sum of components (A1), (A2) and (A3) to component (B) is from 100:0 to 20:80, preferably from 100:0 to 40:60.

The polyether polyacrylate (A) can be prepared in a feed technique by a free-radical polymerization which is known per se and is described for example in EP-A-580 054. Generally speaking at least 50% by weight of component (A2), preferably 100% by weight, are charged to the polymerization vessel and heated to the reaction temperature, which is from 80 to 220° C. Subsequently the monomer mixture (A1), fractions of components (A2) and (A3) where appropriate, and a polymerization initiator (D) are metered in. After the end of the addition the reaction is completed by subsequent stirring at a temperature which is from 0 to 80° C., preferably 0 to 50° C., below the original reaction temperature. Component (B) is added only after the polymerization has reached an end.

The invention also provides a process for preparing the binder mixture of the invention, characterized in that component (A2) is introduced initially and heated and then the monomer mixture (A1), where appropriate with fractions of components (A2) and (A3), and a polymerization initiator (D) are metered in and polymerized. Preferably the fatty alcohol (B) is added subsequently.

Examples of suitable polymerization initiators (D) include, but are not limited to dibenzoyl peroxide, di-tert-butyl peroxide, dilauryl peroxide, dicumyl peroxide, didecanoyl peroxide, tert-butyl peroxy-2-ethylhexanoate, tert-butyl perpivalate or butyl peroxybenzoate and also azo compounds, e.g. 2,2′-azobis(2,4-dimethyl-valeronitrile), 2,2-azobis-(isobutyronitrile), 2,2′-azobis(2,3-dimethylbutyronitrile), 1,1′-azobis-(1-cyclohexanenitrile). Other industrially available free-radical initiators can also be employed. Preference is given to the peroxides, particular preference to dicumyl peroxide and di-tert-butyl peroxide.

It may be necessary by subsequent addition of small amounts of initiator to perform a reactivation in order to achieve complete monomer conversion. If in exceptional cases an inadequate conversion is found after the reaction has been terminated, and relatively large amounts of starting compounds are still present in the reaction mixture, they can either be removed by distillation or brought to reaction by further reactivation with initiator accompanied by heating at reaction temperature.

In the preparation of the polyether polyacylate (A) it is possible where appropriate to use auxiliaries and additives as well, such as molecular weight regulator substances, e.g. n-dodecyl mercaptene, tert-dodecyl mercaptan or the like, the α-olefins with low polymerization tendency that are described in EP-A 471 258 (page 5, lines 24-36) and the derivatized dienes described in EP-A 597 747 (page 1, lines 40-58m page 3 lines 1-11) employed. These compounds are used in amounts of up to 20% by weight, preferably up to 10% by weight, based on the total weight of component (A).

If desired the antioxidants and/or light stabilizers known in coating technology can be added as stabilizers to the solvent-free binder mixtures of the invention in order to achieve further improvement in the light stability and weather stability of the polyether polyacrylates (A). With preference, however, the coating compositions of the invention are used in stabilizer-free form.

Examples of suitable antioxidants include sterically hindered phenols such as 4-methyl-2,6-di-tert-butylphenol (BHT) or other substituted phenols (Irganox® series, Ciba Geigy, Basle), thioethers (e.g. Irganox® PS, Ciba Geigy, Basle) or phosphites (e.g. Irgaphos®, Ciba Geigy, Basle).

Examples of suitable light stabilizers include “HALS” amines (Hindered Amine Light Stabilizers) such as Tinuvin® 622D or Tinuvin® 765 (Ciba Geigy, Basle), for example, and also substituted benzotriazoles such as Tinuvin® 234, Tinuvin® 327 or Tinuvin® 571 (Ciba Geigy, Basle), for example.

To prepare the coating compositions comprising the binder mixtures of the invention components (A) and (C) are mixed with one another in proportions such that the NCO:OH equivalents ratio corresponds to from 0.5:1 to 2.0:1, preferably from 0.8:1 to 1.5:1. During or after this mixing of the individual components it is possible if desired to admix the customary auxiliaries and additives of coating composition technology. These include, for example, levelling agents, viscosity regulator additives, pigments, fillers, dulling agents, UV stabilizers and antioxidants, and also catalysts for the crosslinking reaction.

The coating compositions comprising the binder mixtures of the invention are used to produce solvent-free two-component polyurethane coatings. These coatings have a Shore D hardness of at least 50 (DIN 53505).

The present application likewise provides solvent-free two-component polyurethane coatings comprising the binder mixtures of the invention.

It is preferred to use the binder mixtures of the invention to produce coatings for protecting metallic substrates against mechanical damage and corrosion and also for protecting mineral substrates, such as concrete, for example, against environmental effects and mechanical damage. The coat thickness lies in the range from 0.5 to 10 mm, preferably from 0.7 to 6 mm.

Likewise provided by the present invention are substrates coated with coating compositions comprising solvent-free binder mixtures of the invention.

### EXAMPLES

### Components Employed

Desmodur® VL: 4,4′-diphenylmethane diisocyanate-based polyisocyanate having an NCO content of 31.5% and a viscosity at 23° C. of 90 mPa.s, Bayer AG, Leverkusen

Desmophen® 550U: propylene oxide-based branched polyether having a number-average molecular weight of 437 g/mol, a viscosity at 23° C. of 55 mPa.s and an OH content of 11.7%, Bayer AG, Leverkusen

### Examples 1 to 6

General working instructions for preparing the polyether polyacrylates:

Part 1:

| | |
|---|---|
| Desmophen ® 550U | 56.2 (g) |

Part 2:

| | |
|---|---|
| Methyl methacrylate | 7.5 (g) |
| Styrene | 7.5 (g) |
| Butyl acrylate | 1.9 (g) |

Part 3:

| | |
|---|---|
| Di-tert-butyl peroxide | 1.9 (g) |

Part 4:

| | |
|---|---|
| Castor oil | 25 (g) |

The components from part 1 are heated to 165° C. in a reaction vessel with stirring. Over the course of 3 hours part 2 is metered in continuously and part 3 is metered in continuously in parallel therewith over the course of 3.5 hours. After 3 hours the addition of part 3 is interrupted and the mixture is cooled to 140° C. After the temperature has cooled to 140° C. the remainder of part 3 is metered in. After a further 2 hours at 140° C. the product is cooled to room temperature and, where appropriate, part 4 is admixed.

The composition of the products and also the OH content, viscosity and water absorption are given in Table 1.

TABLE 1
Composition and key data of polyether polyacrylates

| | Example (inventive) | | | | | | |
|---|---|---|---|---|---|---|---|
| | 1 | 2 | 3 | 4 | 5 | 6 | (Comparative) 7 |
| Desmophen ® 550U (g) | 75 | 70.00 | 60 | 56.25 | 37.5 | 18.75 | 75 |
| Styrene (g) | 10 | 9.00 | 8.00 | 7.5 | 5 | 2.5 | 10 |
| Methyl methacrylate (g) | 10 | 9.00 | 8.00 | 7.5 | 5 | 2.5 | — |
| Hydroxymethyl methacrylate (g) | — | — | — | — | — | — | 10 |
| Butyl acrylate (g) | 2.5 | 2.25 | 2.00 | 1.875 | 1.25 | 0.625 | — |
| Hydroxymethyl acrylate (g) | — | — | — | — | — | — | 2.5 |
| Di-tert-butyl peroxide (g) | 2.5 | 2.25 | 2.00 | 1.875 | 1.25 | 0.625 | 2.5 |
| Castor oil (g) | 0 | 0 | 0 | 25 | 50 | 75 | 0 |
| Key data | | | | | | | |
| Viscosity, 23° C., mPa · s | 2600 | 2190 | 1815 | 1515 | 1086 | 872 | 5880 |
| OH content (%) | 8.7 | 8.4 | 8.0 | 7.8 | 6.9 | 5.9 | 10.8 |
| Water absorption after 21 days, | 7.7 | 6.9 | 5.8 | 4.1 | 2.3 | 1.1 | 10.6 |
| 23° C. (%)^{a} | | | | | | | |
| ^{a}Water absorption: The water absorption was determined as the increase in weight after conditioning. 10 g of polyol were dried at 100° C. for 24 hours and weighed. The polyol sample was subsequently conditioned over water in a desiccator at 23° C. for 21 days and after this was weighed again. The water | | | | | | | |
| # absorption was calculated in accordance with the following formula: Water absorption = weight increase * 100/initial weight (%) | | | | | | | |

### Example 10 to 18

General working instructions for preparing the binder mixtures and their use:

The polyisocyanate and the polyether polyacrylate are admixed where appropriate with catalyst and additives and mixed to homogeneity. The binder mixture is then applied to the test substrate. The composition and the final Shore D hardness are given in Table 2.

TABLE 2
Composition and final Shore D hardness of the binder mixtures

| | Example | | | | | | |
|---|---|---|---|---|---|---|---|
| | 10 | 11 | 12 | 13 | 14 | 15 | 16* |
| Example 1 | 100 | | | | | | |
| Example 2 | | 100 | | | | | |
| Example 3 | | | 100 | | | | |
| Example 4 | | | | 100 | | | |
| Example 5 | | | | | 100 | | |
| Example 6 | | | | | | 100 | |
| Example 7 | | | | | | | 100 |
| Desmodur ® VL^{c} | 71.6 | 69.2 | 67.5 | 64.2 | 56.8 | 48.6 | 88.9 |
| NCO:OH eq. ratio | 1.05:1 | 1.05:1 | 1.05:1 | 1.05:1 | 1.05:1 | 1.05:1 | 1.05:1 |
| Processing time^{a} | 60 | 60 | 60 | 60 | 60 | 60 | 30 |
| (min) | | | | | | | |
| Shore D hardness to | 75 | 75 | 75 | 75 | 65 | 50 | 75 |
| DIN 53505 | | | | | | | |

*comparative example
^{a}time within which the binder mixture can be processed manually without stringing

The inventive examples (1-6) possess a low water absorption in combination with a low viscosity and at the same time exhibit a high hardness in the coating. Example 7 exhibits a high water absorption and viscosity. On addition of castor oil the mixture from Example 7 becomes cloudy.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A solvent-free binder mixture comprising a hydrophobic polyether poly-acrylate (A) including the reaction product of the components comprising
(A1) a mixture of non-hydroxy-functional acrylic and styrenic monomers or copolymers thereof,
(A2) hydroxy-functional polyethers (A2),
(A3) if desired, hydroxy-functional compounds having a molecular weight Mₙ of from 32 to 1000 which are other than (A2),
wherein the solvent-free binder mixture has a water absorption of less than 8%, (measured after 21 days and at 23° C.).

2. The solvent-free binder mixture according to claim 1, characterized in that the water absorption is less than 5%.

3. The solvent-free binder mixtures according to claim 1, wherein the hydrophobic polyether polyacrylate (A) further comprises a fatty alcohol (B).

4. The solvent-free binder mixtures according to claim 3, characterized in that the fatty alcohol (B) is castor oil.

5. The solvent-free binder mixtures according to claim 1, characterized in that the viscosity of the binder mixtures is from 200 to 3000 mPa.s (at 23° C.) and the OH content is from 3 to 10% by weight.

6. The solvent-free binder mixtures according to claim 1, characterized in that component (A2) comprises polyetherpolyols having 2 or more hydroxyl groups per molecule.

7. The solvent-free binder mixtures according to claim 1, characterized in that component (A2) comprises polyethers composed of at least 50%, based on the sum of their repeating units, of repeating units of the structure —CH(CH₃)CH₂O—.

8. A Process for preparing solvent-free binder mixtures comprising the steps of providing
(A1) a mixture of non-hydroxy-functional acrylic and styrenic monomers or copolymers thereof,
(A2) hydroxy-functional polyethers (A2),
(A3) optionally, hydroxy-functional compounds having a molecular weight Mₙ of from 32 to 1000 which are other than (A2), introducng and heating at least a portion of component (A2) adding the monomer mixture (A1) to the portion of (A2), adding at least a portion of component (A3) to the portion of (A2), and metering any remaining fractions of components (A2) and (A3), and a polymerization initiator (D) into the mixture of (A1), (A2) and (A3) to effect polymerization.

9. The process according to claim 8, characterized in that after the polymerization a fatty alcohol (B) is added.

10. A two-component polyurethane coating compositions comprising the binder mixtures according to claim 1 and a polyisocyanate (C), wherein the NCO:OH equivalents ratio is from 0.5:1 to 2.0:1.

11. A two-component polyurethane coating comprising binder mixtures according to claim 1.

12. The two-component polyurethane coatings according to claim 11, characterized in that the coatings have a Shore D hardness of at least 50 according to DIN 53505.

13. A method of protecting metallic or mineral substrates comprising applying the solvent-free binder mixtures according to claim 1 to a metallic substrate or a mineral substrate to produce a coating thereon.

14. A Substrate coated with the coating composition comprising solvent-free binder mixtures according to claim 1.
